(19) United States
(12) Patent Application Publication
(10) Pub. No.: US 2012/0025993 A1
(43) Pub. Date: Feb. 2, 2012

(54) DEVICE RESPONDING TO IMPROPER DRIVE

(75) Inventor: Tomonori Akiyama, Shizuoka (JP)

(73) Assignee: TOYOTA JIDOSHA KABUSHIKI KAISHA, Toyota-shi (JP)

(21) Appl. No.: 13/262,984

(22) PCT Filed: Apr. 23, 2009
(86) PCT No.: PCT/JP09/58081

§ 371 Date: Oct. 5, 2011

(51) Int. Cl. G08B 23/00

(52) U.S. Cl. 340/576

(57) ABSTRACT

There is provided a device responding to improper drive for providing drive support based on a driver's alertness, the device including a support unit that changes the control mode from a drive support mode to a sleepiness responding mode depending on the driver's alertness during an execution of a first control mode, wherein the support unit changes the control mode after the notification unit notifies the driver. The device can provide optimal response to a driver.

### TECHNICAL FIELD

The present invention relates to a device responding to improper drive.

### BACKGROUND ART

In the related art, there is known a device responding to improper drive capable of warning a driver depending on the driver's alertness. For example, Patent Literature 1 discloses a device that detects a driver's condition, computes alertness, and generates alarm when the computed alertness and a threshold value satisfy a predetermined magnitude relationship.

### CITATION LIST

### Patent Literature 1

Japanese Unexamined Patent Application Publication No. 10-40481

### SUMMARY OF INVENTION

### Technical Problem

However, in the device disclosed in Patent Literature 1, since only a process for increasing the driver's alertness is carried out, the alarm may not attract the driver's attention, or it may be difficult to sufficiently improve traveling safety.

In this regard, the invention has been made to address the aforementioned problems, and an object thereof is to provide a device responding to improper drive capable of providing drivers with optimal responses.

### Solution to Problem

According to an aspect of the invention, there is provided a device responding to improper drive for providing drive support based on a driver's alertness, the device including: a support processing unit that changes from a first control mode to a second control mode depending on the driver's alertness during an execution of the first control mode; and a notification unit that notifies a driver of the fact that the support processing unit changes to the second control mode, wherein the support processing unit changes the control mode after the notification unit notifies the driver.

In the device responding to improper drive according to an aspect of the invention, in a case where the support processing unit changes from the first control mode to the second control mode depending on the driver's alertness, the notification unit notifies the driver of the change of the control mode to the second control mode, and then, the support processing unit changes from the first control mode to the second control mode. Since information on the operation of the device is notified, the driver is allowed to determine whether or not the device is operating normally. Therefore, it is possible to prevent the driver from being confused or overconfident. For example, even when a device malfunction, error detection, or the like occurs, it is possible to alleviate the driver's discomfort or distrustfulness and provide the driver with an optimal response.

It is preferable that the support processing unit change the control mode at a time interval after the notification unit notifies the driver. In this configuration, it is possible to set a time to make the driver understand the operation executed by the device. Therefore, it is possible to further prevent the driver from being confused or overconfident.

Preferably, the device responding to improper drive according to an aspect of the invention may further include an input unit that receives an instruction for aborting the change to the second control mode from the driver after the notification unit notifies the driver before the support processing unit changes the control mode, wherein the support processing unit aborts the change of the control mode when the input unit receives the instruction. In this configuration, it is possible to abort control of the device through an instruction from a driver. Therefore, it is possible to provide a driver with an optimal response.

According to another aspect of the invention, there is provided a device responding to improper drive for providing drive support based on the driver's alertness, the device including a support processing unit that aborts a first support function for alleviating a drive burden depending on the driver's alertness during the first support function and initiates a second support function focusing on drive safety or travel safety.

In the device responding to improper drive according to another aspect of the invention, the first support function for alleviating a drive burden is aborted by the support processing unit depending on the driver's alertness during the first support function, and the second support function focusing on drive safety or travel safety is initiated. For this reason, for example, in a case where the driver's alertness is lowered, the overall drive support is not aborted, but the support focusing on driving or traveling safety may be provided. Therefore, it is possible to provide a driver with an optimal response.

### Advantageous Effects of Invention

According to the invention, it is possible to provide a driver with an optimal response.

### BRIEF DESCRIPTION OF DRAWINGS

FIG. 1 is a block diagram illustrating a configuration of a vehicle having a device responding to improper drive according to an embodiment of the invention.

FIG. 2 is a flowchart illustrating an operation of the device responding to improper drive according to an embodiment of the invention.

FIG. 3 is a schematic diagram illustrating an operation of the device responding to improper drive according to a first embodiment of the invention.

FIG. 4 is a schematic diagram illustrating an operation of the device responding to improper drive according to a first embodiment of the invention.

FIG. 5 is a schematic diagram illustrating an operation of the device responding to improper drive according to a first embodiment of the invention.

FIG. 6 is a schematic diagram illustrating an operation of the device responding to improper drive according to a second embodiment of the invention.

FIG. 7 is a schematic diagram illustrating an operation of the device responding to improper drive according to a second embodiment of the invention.

### DESCRIPTION OF EMBODIMENTS

Hereinafter, embodiments of the invention will be described with reference to the accompanying drawings. Throughout the drawings, like reference numerals denote like elements, and description thereof will not be repeated.

### First Embodiment

A device responding to improper drive according to the first embodiment is preferably employed to respond to improper drive such as sleepy driving by the driver.

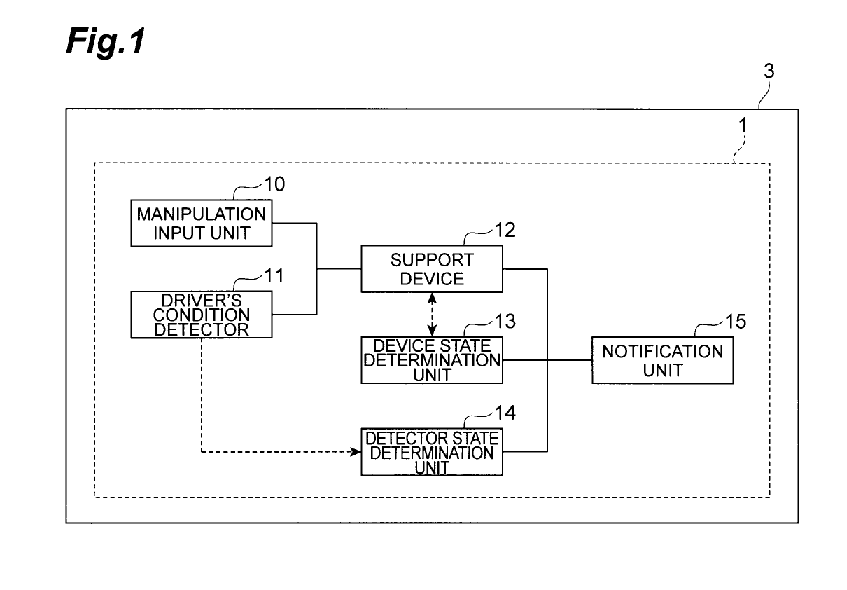

First, an exemplary configuration of a vehicle including the device responding to improper drive according to the present embodiment will be described. FIG. 1 is a block diagram illustrating a configuration of the vehicle including the device responding to improper drive according to an embodiment of the present embodiment. As shown in FIG. 1, the vehicle 3 includes a driver's condition detector 11 and a support device 12 (such as a support processing unit, a notification unit).

The driver's condition detector 11 acts to detect the driver's condition. For example, the driver's condition detector 11 acts to detect driver fatigue, sleepiness, or the driver's condition and the like. For example, the driver's condition detector 11 may act to obtain images and detect driver fatigue or sleepiness based on the movement of the driver's eyelids and the like. Alternatively, the driver's condition detector 11 may act to obtain physiological information such as a brain wave, a cardiac rate, or a blood pressure, and detect driver fatigue, sleepiness, or condition based on the obtained physiological information. In addition, the driver's condition detector 11 may act to evaluate the detected driver's condition as alertness and output it to the support device 12. Here, alertness refers to the degree to which the driver is awake. The higher the alertness value, the more the driver's level of consciousness is being maintained. The driver's condition detector 11 may evaluate the alertness based on techniques of the related art.

The support device 12 has a central processing unit (CPU), a read-only memory (ROM), a random access memory (RAM), an input/output interface, and the like, and acts to support the driving or traveling of a vehicle based on information obtained from sensors (not shown) provided in the vehicle 3. For example, the support device 12 has at least one function of supporting driving in terms of drive convenience (for example, a support function for alleviating a drive burden) and at least one function of supporting driving in terms of driving or travel safety. For example, the support device 12 includes a drive support system such as adaptive cruise control (ACC), lane-keeping assist (LKA), lane departure warning (LDW), lane departure prevention (LDP), and pre-crash safety (PCS) systems. For example, an acceleration function of ACC, the LKA, and the like are drive support functions focusing on drive convenience. For example, the deceleration control of ACC, LDW, LDP, PCS, and the like are drive support functions focusing on drive or travel safety.

The support device 12 is configured to change the drive support items depending on change of the control mode. For example, the support device 12 may include a control mode such as a drive support mode for supporting a driver whose alertness is not deteriorating, a sleepiness responding mode for responding to a drowsy driver, and the like. The drive support mode is a control mode for activating functions of, for example, the ACC, the LKA, and the like. In addition, the sleepiness responding mode is a control mode for aborting a (first) support function for alleviating a drive burden among the drive support functions being executed, and activating a (second) support function focusing on drive or travel safety. In addition, the support device 12 is configured to change the drive support items depending on switching (transition) of the control mode.

The support device 12 acts to change the drive support items based on the driver's alertness evaluated by the driver's condition detector 11. For example, the support device 12 is configured to execute the drive support mode focusing on drive convenience when the driver's alertness is equal to or higher than a predetermined threshold value. In addition, the support device 12 is configured to execute a sleepiness responding mode focusing on driving or traveling safety when the driver's alertness is lower than a predetermined threshold value. As a predetermined threshold value, for example, a value computed in advance through simulation or experiment may be used.

The support device 12 is connected to the notification unit 15 to operatively activate the notification unit 15. The notification unit 15 may include, for example, an indicator, a display, a loudspeaker, a vibrator, and the like. In a case where the drive support items are changed, the support device 12 acts to operate the notification unit 15 before changing the control mode to notify a driver of the control mode to be changed. Here, the support device 12 may act to change the control mode at a time interval after the support device 12 notifies a driver of the control mode to be changed. As the time interval, for example, ten or thirty seconds, or one minute may be used. The support device 12 may change the time interval depending on, for example, alertness, a detail of notification, or the number of characters for notification, and the like. In addition, the support device 12 may act to notify a driver of the time interval for changing the control mode.

For example, the support device 12 may act to notify a driver of the timing for changing the control mode during a time interval after the control mode to be changed is notified to a user before the control mode is changed or simultaneously with the timing for notifying a driver of the control mode to be changed. In order to notify the timing for changing the control mode, an indication may be displayed, for example, using a barometer, an indicator, a display, and the like, or sound may be output from a loudspeaker.

The support device 12 is connected to the manipulation input unit 10 that inputs manipulation from a driver. The manipulation input unit 10 acts to input manipulation for aborting the change of the control mode. For the manipulation for aborting the change of the control mode, for example, a switch, a button, a touch panel, a steering, an acceleration pedal, a brake pedal, and the like may be manipulated, or a voice instruction may be used. In addition, the manipulation input unit 10 acts to output a manipulation signal to the support device 12. The support device 12 acts to abort the change of the control mode when the manipulation signal is output from the manipulation input unit 10.

In addition, the vehicle 3 includes a detector state determination unit 14 for determining a state of the driver's condition detector 11 and a device state determination unit 13 for determining a state of the support device 12.

The detector state determination unit 14 acts to, for example, monitor an operational state of the driver's condition detector 11 and determine whether or not functions of the device are normally operated. The detector state determination unit 14 acts to determine malfunction, trouble, or error detection of the driver's condition detector 11 by obtaining an error message of the driver's condition detector 11 or evaluating the validity of the value detected by the driver's condition detector 11.

The detector state determination unit 14 is connected to the notification unit 15 so as to be able to operate the notification unit 15. In a case where the function of the driver's condition detector 11 is not operating normally, the detector state determination unit 14 operates the notification unit 15 to notify the driver of the fact that the detector state determination unit 14 is not operating normally.

The device state determination unit 13 acts to, for example, monitor the operational state of the support device 12 and determine whether or not the function of the device is operating normally. The device state determination unit 13 acts to detect malfunction or trouble in the support device 12, for example, based on the error message of the support device 12 and determine whether or not the support device 12 is operating normally. Alternatively, the device state determination unit 13 may act to determine whether or not the support device 12 is operating normally based on a travel state or an environmental state.

The device state determination unit 13 is connected to the notification unit 15 so as to be able to operate the notification unit 15. The device state determination unit 13 acts to operate the notification unit 15 to notify a driver of the fact that the support device 12 is not operating normally in a case where the support device 12 is not operating normally.

The device 1 responding to improper drive includes the driver's condition detector 11, the support device 12, the manipulation input unit 10, the device state determination unit 13, and the detector state determination unit 14 described above. In addition, the manipulation input unit 10, the device state determination unit 13, and the detector state determination unit 14 may be suitably included depending on necessary performance.

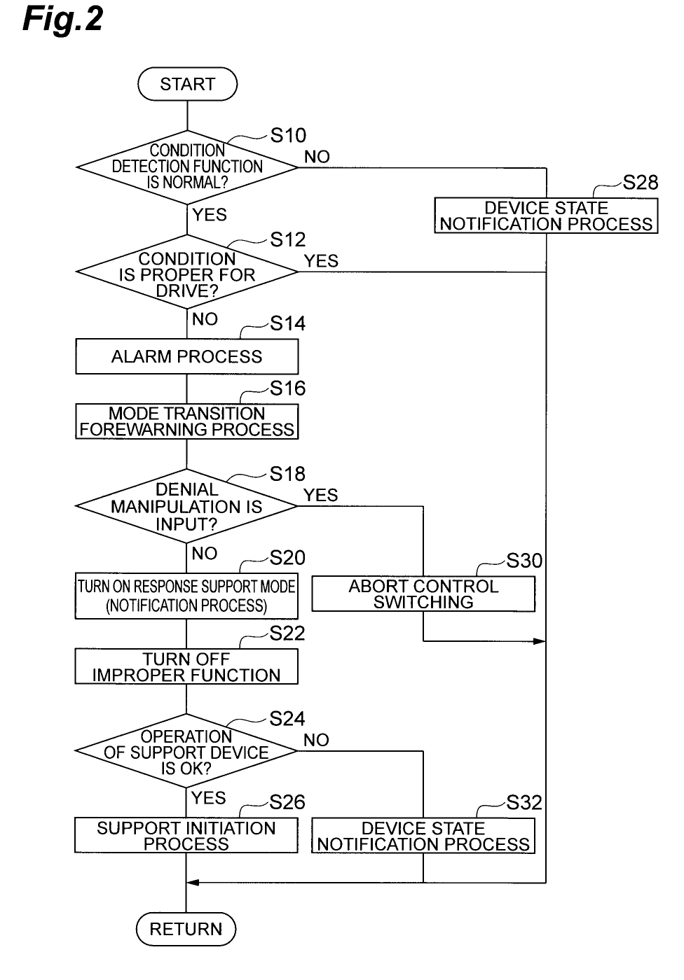

Next, the operation of the device 1 responding to improper drive according to an embodiment of the invention will be described. FIG. 2 is a flowchart illustrating an operation of the device 1 responding to improper drive according to an embodiment of the invention. The control process shown in FIG. 2 is repeatedly performed at a predetermined interval, for example, at the timing of ignition-on. Hereinafter, for the purpose of facilitating understanding, the operation of the device 1 responding to improper drive corresponding to the sleepiness drive will be described. Here, it is assumed that the drive support mode for activating ACC and LKA is executed when driver's level of consciousness is not deteriorating.

As shown in FIG. 2, first, the device 1 responding to improper drive initiates a condition detection function determination process (S10). In the process S10, the detector state determination unit 14 is operated to determine whether or not the detection function of the driver's condition detector 11 is normal. In the process S10, in a case where the detector state determination unit 14 determines that the detection function of the driver's condition detector 11 is not normal, the flow advances to a device state notification process (S28).

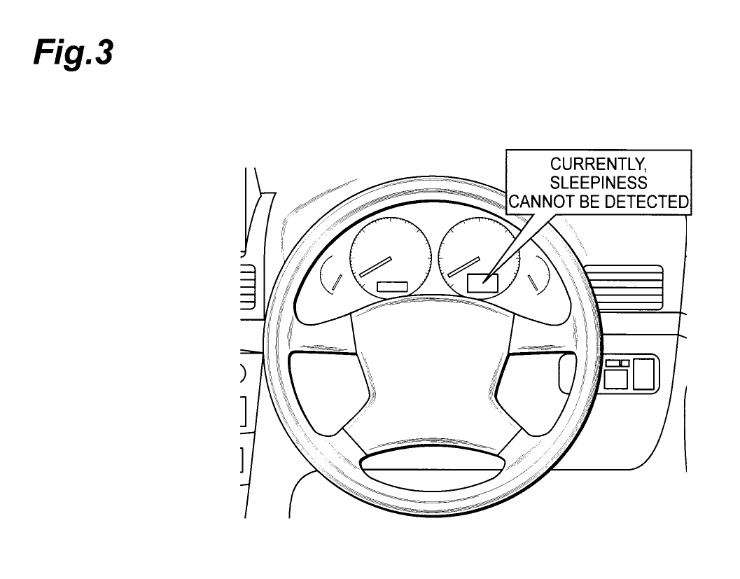

In the process S28, the detector state determination unit 14 is activated to operate the notification unit 15 to notify a driver of the fact that the detection function of the driver's condition detector 11 is not normal. For example, the detector state determination unit 14 operates the multi-information display provided in a part of a display unit where a speedometer or the like is arranged so as to display a message such as “CURRENTLY, SLEEPINESS CANNOT BE DETECTED” as shown in FIG. 3. While such an indication is displayed, the detector state determination unit 14 may operate a loudspeaker to output a voice or a buzzer sound or may provide a tactile alarm such as seat vibration or seat belt roll-up. As the process S28 is terminated, the control process of FIG. 2 is also terminated. As such, since the fact that the detection function of the driver's condition detector 11 is not normal is notified to a driver, a driver can be made aware that there is a problem with the device. Therefore, it is possible to alleviate driver's distrustfulness, discomfort, stress, and the like.

Meanwhile, in the process S10, in a case where the detector state determination unit 14 determines that the detection function of the driver's condition detector 11 is normal, the flow advances to a drive condition determination process (S12). In the process S12, the support device 12 is operated to determine whether or not a driver's condition is suitable for driving. The support device 12 computes, for example, the driver's alertness based on information output from the driver's condition detector 11. The support device 12 determines whether or not a driver's condition is suitable for driving, for example, based on a magnitude relationship between the computed alertness and a predetermined threshold value. If the support device 12 determines that a driver's condition is suitable for driving in the process S12, there is little necessity to support the driver, and thus, the control process of FIG. 2 is terminated. Otherwise, if the support device 12 determines that a driver's condition is not suitable for driving in the process S 12, the flow advances to an alarm process (S14).

In the process S14, the support device 12 is activated to operate the notification unit 15 to turn on a warning light, or output an alarm message, alarm sound, or alarm vibration. As the process S14 is terminated, the flow advances to a mode transition forewarning process (S16).

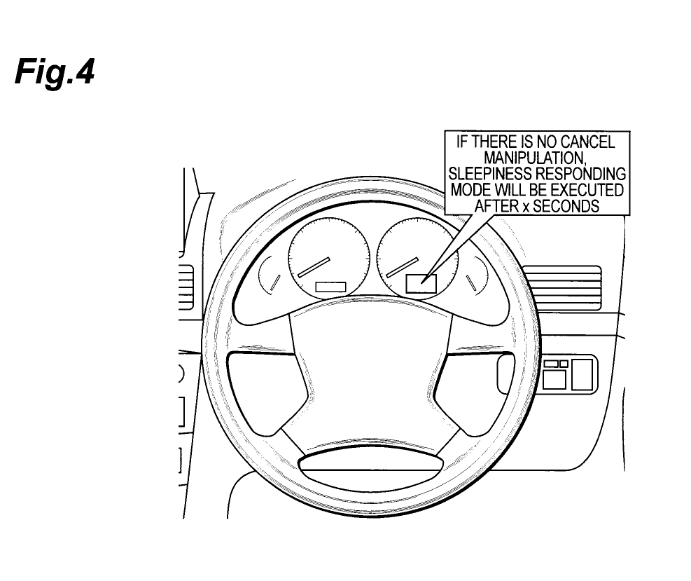

In the process S16, the support device 12 is activated to operate the notification unit 15 to forewarn a driver of the fact that the control mode will be transitioned. Here, as the control corresponding to the sleepiness drive, a case where a sleepiness responding mode is executed will be exemplarily described. For example, as shown in FIG. 4, the support device 12 operates the multi-information display provided in a part of the display unit where a speedometer and the like are arranged to display a message such as “IF THERE IS NO CANCEL MANIPULATION, SLEEPINESS RESPONDING MODE WILL BE EXECUTED AFTER X SECONDS.” As the process S16 is terminated, the flow advances to a denial manipulation input determination process (S18).

In the process S18, the support device 12 is activated to determine whether or not an instruction for canceling change to the sleepiness responding mode is received from a driver via the manipulation input unit 10. In the process S18, if it is determined that the support device 12 receives an instruction for canceling change of the sleepiness responding mode through the manipulation input unit 10 within a predetermined time period (for example, ten or thirty seconds, one minute, or the like), the flow advances to a control mode change abort process (S30).

In the process S30, the support device 12 is activated to abort the change to the sleepiness responding mode. As the process S30 is terminated, the control process shown in FIG. 2 is terminated. As such, if the instruction for canceling change to the sleepiness responding mode is received from a driver through the manipulation input unit 10, the change to the sleepiness responding mode is aborted. Therefore, it is possible to provide support by reflecting a driver's intention. Accordingly, it is possible to provide support as desired by a driver. In addition, since the detector state determination unit 14 detects an error, it is possible to prevent an alert driver from being provided with a sleepiness responding support.

Meanwhile, in the process S18, in a case where it is determined that the support device 12 does not receive the instruction for canceling the change to the sleepiness responding mode through the manipulation input unit 10 within a predetermined time period, the flow advances to a responsive support mode execution process (S20).

In the process S20, the support device 12 is activated to execute a responsive support mode. Here, the responsive support mode refers to the support mode forewarned in the process S16, and is set to the sleepiness responding mode in this case. The support device 12 transitions from the drive support mode to the sleepiness responding mode, and operates the notification unit 15 to notify the driver of this fact. As the process S20 is terminated, the flow advances to a function abort process (S22).

In the process S22, the support device 12 is activated to perform vehicle control in the sleepiness responding mode. The sleepiness responding mode is a control mode for turning off a support function for alleviating a drive burden among the drive support functions being executed and turning on a support function focusing on driving or traveling safety in a case where the support function focusing on driving or traveling safety is turned off. The support device 12 turns off the acceleration function of the ACC among the ACC functions being executed and turns on only the deceleration function of the ACC. Since the vehicle of a drowsy driver is accelerated by the acceleration function of the ACC, it is difficult to say that it is a support for improving travel safety. In addition, the support device 12 turns off, for example, a function of LKA being executed, and turns on the functions of LDW, LDP, and PCS that are not being executed. This is because the function of LKA may cause sleepiness since it provides a vehicle with lane keeping control. As such, when a driver is dozing, not all of the drive supports are turned off, the support function for alleviating a drive burden is turned off, and the function focusing on driving or traveling safety (a function of improving drive or travel safety) is newly turned on. Therefore, it is possible to provide a driver with optimal support. As the process S22 is terminated, the flow advances to a device state determination process (S24).

In the process S24, the device state determination unit 13 is activated to determine whether or not the function of the support device 12 is operating normally. For example, the device state determination unit 13 obtains an error message of the support device 12 and determines whether or not the support device 12 suffers from malfunction or trouble. Alternatively, the device state determination unit 13 determines whether or not the function of the support device 12 is operating normally based on a travel state or an environmental state. For example, when the traffic lane is not detected, it is impossible to execute the LDP support. Therefore, the device state determination unit 13 determines that it is impossible to normally operate the function of LDP of the support device 12. In the process S24, if the device state determination unit 13 determines that it is possible to normally operate the function of the support device 12, the flow advances to a support initiation process (S26).

In the process S26, the support device 12 is activated to operate the functions turned on in the process S22. As such, since the timing for turning off the support function for alleviating a drive burden is set to be earlier than the timing for initiating the support focusing on drive or travel safety, it is possible to quickly prevent the driver's sleepiness from increasing using the support function for alleviating a drive burden. Therefore, it is possible to quickly prevent a deterioration in alertness. As the process S26 is terminated, the control process shown in FIG. 2 is terminated.

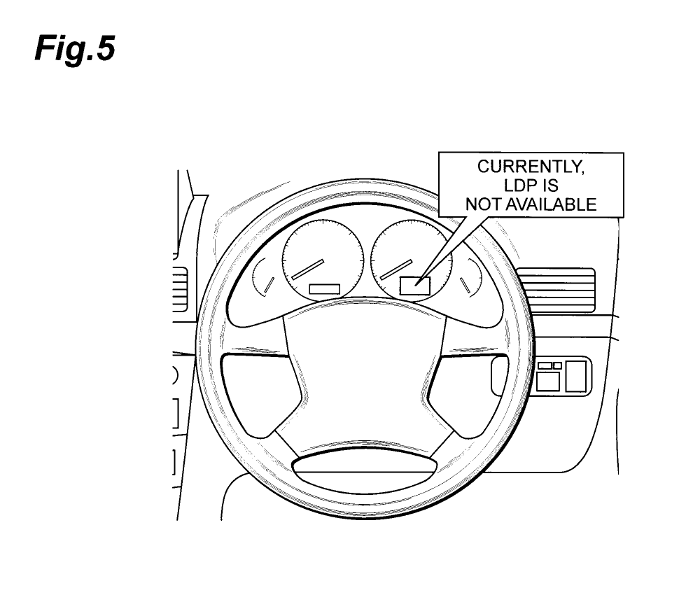

Meanwhile, if the device state determination unit 13 determines that the function of the support device 12 is not operating normally in the process S24, the flow advances to a device state notification process (S32). In the process S32, the device state determination unit 13 is operated to notify the driver of the determination result of the process S24. For example, assuming that it is not possible to execute the LDP due to a certain reason in the process S24, the device state determination unit 13 operates a multi-information display provided in a part of the display unit where a speedometer and the like are arranged to display a message such as “CURRENTLY, LDP IS NOT AVAILABLE” as shown in FIG. 5. As the process S32 is terminated, the control process of FIG. 2 is terminated. As a result, when an effective support is executed for sleepiness, or when it is impossible to execute a part of or the entire control of the support after an effective support for sleepiness is turned on, this fact is notified to a driver. Therefore, even when the support is not provided after the mode transition is declared, it is possible to alleviate driver's distrustfulness, discomfort, stress, and the like.

As described above, in the device 1 responding to improper drive according to the first embodiment, when the driver's alertness is lower than a threshold value, the support device 12 notifies a driver of the fact that the mode will be changed to the sleepiness responding mode, and then, the support device 12 changes the control mode from the drive support mode to the sleepiness responding mode. By providing notification of information on the device operation, it is possible to allow a driver to determine whether or not the device is operating normally. Therefore, it is possible to prevent a driver from being confused or overconfident. As a result, for example, even when a malfunction or error detection occurs in the device, it is possible to alleviate driver's discomfort or distrustfulness. Therefore, it is possible to abort the control of the device based on a driver's instruction. In addition, it is possible to provide a driver with an optimal response.

In the device 1 responding to improper drive according to the first embodiment, the support device 12 may change to the sleepiness responding mode after a predetermined time period subsequent to notification to a driver. Therefore, it is possible to set a time for making a driver understand the operation executed by the device. Therefore, it is possible to further prevent a driver from being confused or overconfident.

In the device 1 responding to improper drive according to the first embodiment, in a case where an instruction for aborting change to the sleepiness responding mode is received from a driver through the manipulation input unit 10 within a predetermined time period, the change to the sleepiness responding mode is aborted by the support device 12. Therefore, it is possible to provide a driver with an optimal response.

In the device 1 responding to improper drive according to the first embodiment, in a case where driver's alertness is lower than a threshold value while the support function for alleviating a drive burden is executed, the support device 12 aborts the function being executed and initiates the support focusing on drive or travel safety. As such, in a case where driver's alertness is lower than the threshold value, the overall drive support is not aborted, but the support focusing on driving or traveling safety may be provided. Therefore, it is possible to provide a driver with an optimal response.

### Second Embodiment

The device responding to improper drive according to the second embodiment is similar to the device 1 responding to improper drive according to the first embodiment, but they differ in the support items executed by the support device 12. In the second embodiment, description for portions similar to those of the first embodiment will not be repeated, and only differences therebetween will be described.

The configuration of the device responding to improper drive according to the second embodiment is nearly the same as the device 1 responding to improper drive according to the first embodiment. They differ in that an emergency responding mode is provided for supporting a driver who is unconscious due to sudden illness or the like as the control mode of the support device 12. The emergency responding mode is a control mode, for example, for aborting the (first) support function for alleviating a drive burden among the drive support functions being executed and activating the (second) support function focusing on drive or travel safety.

Next, operation of the device responding to improper drive according to the second embodiment will be described. Since the operation of the device responding to improper drive according to the second embodiment is nearly the same as that of the device 1 responding to improper drive according to the first embodiment, description will be made with reference to FIG. 2. For example, the control process of FIG. 2 is repeatedly executed at a predetermined interval at an ignition-on timing. In addition, it is assumed that a drive support mode for activating ACC and LKA is executed when a driver is conscious. Description for the processes similar to those of the first embodiment will not be repeated.

As shown in FIG. 2, first, the device 1 responding to improper drive initiates a condition detection function determination process (S10). In the process S10, if it is determined by the detector state determination unit 14 that a function of detecting biological information of the driver's condition detector 11 is not normal, the flow advances to a device state notification process (S28).

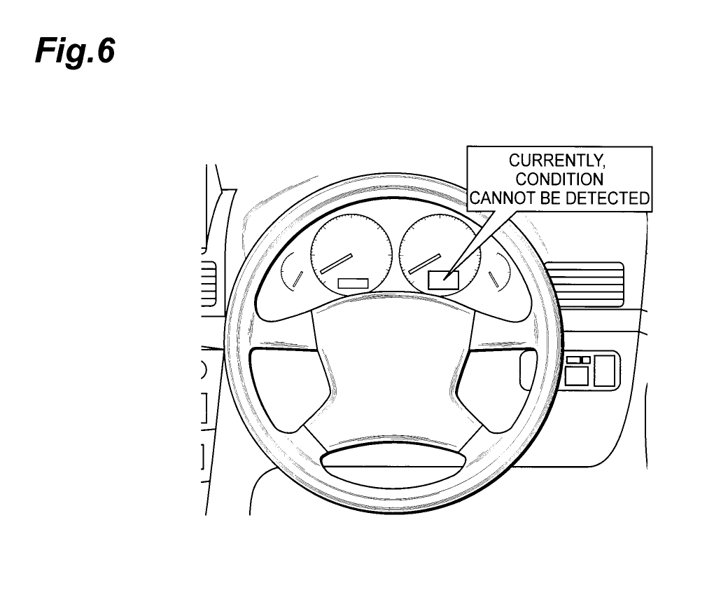

In the process S28, the detector state determination unit 14 is activated to operate the notification unit 15 for notifying a driver of the fact that the function of detecting the biological information of the driver's condition detector 11 is not normal. For example, the detector state determination unit 14 operates the multi-information display provided in a part of the display unit where a speedometer and the like are arranged to display characters such as “CURRENTLY, CONDITION CANNOT BE DETECTED” as shown in FIG. 6. While such an indication is displayed, the detector state determination unit 14 may operate a loudspeaker to output a voice or a buzzer sound. Alternatively, a tactile alarm such as seat vibration or seat belt roll-up may be performed. As the process S28 is terminated, the control process of FIG. 2 is terminated. As such, since a driver is notified of the fact that the function of detecting biological information of the driver's condition detector 11 is not normal, the driver can be made aware that the device has a problem. Therefore, it is possible to alleviate the driver's distrustfulness, discomfort, stress, and the like.

Meanwhile, if the detector state determination unit 14 determines that the detection function of the driver's condition detector 11 is normal in the process S10, the flow advances to a drive condition determination process (S12). The process S12 is a process for determining whether or not a driver's condition is suitable for driving using the support device 12. The support device 12 determines, for example, whether or not a driver suffers from a cardiac disease or symptoms based on the biological information output from the driver's condition detector 11. If the support device 12 determines that the driver's condition is suitable for driving in the process S12, necessity to support a driver is insufficient, and thus, the control process of FIG. 2 is terminated. Meanwhile, if the support device 12 determines that the driver's condition is not suitable for driving in the process S12, the flow advances to an alarm process (S14).

The process S14 is similar to that described in conjunction with the first embodiment. As the process S14 is terminated, the flow advances to a mode transition forewarning process (S16).

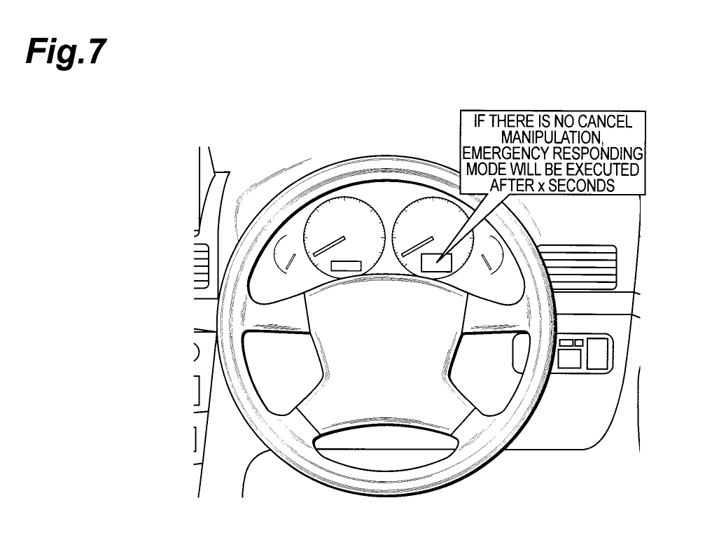

In the process S16, the support device 12 is activated to operate the notification unit 15 for forewarning a driver of the fact that the control mode will be transitioned. Here, a case where an emergency responding mode is executed as control for responding to emergency will be exemplarily described. For example, the support device 12 operates the multi-information display provided in a part of the display unit where a speedometer and the like are arranged to display characters such as “IF THERE IS NO CANCEL MANIPULATION, EMERGENCY RESPONDING MODE WILL BE EXECUTED AFTER X SECONDS” as shown in FIG. 7. As the process S16 is terminated, the flow advances to a denial manipulation input determination process (S18).

In the process S18, the support device 12 is activated to determine whether or not an instruction for canceling change to the emergency responding mode is received from a driver through the manipulation input unit 10. In the process S18, if the support device 12 determines that the instruction for canceling change to the emergency responding mode is received through the manipulation input unit 10 within a predetermined time period, the flow advances to a control mode change abort process (S30).

In the process S30, the support device 12 is activated to abort change to the emergency responding mode. As the process S30 is terminated, the control process of FIG. 2 is terminated. As such, in a case where an instruction for canceling change to the emergency responding mode is received from a driver through the manipulation input unit 10, the change to the emergency responding mode is aborted. Therefore, it is possible to provide support as desired by a driver. In addition, by detecting an error using the detector state determination unit 14, it is possible to prevent a normal driver who is not sick from being provided with emergency responding support.

Meanwhile, if the support device 12 determines that an instruction for canceling change to the emergency responding mode is not received through the manipulation input unit 10 within a predetermined time period in the process S18, the flow advances to a responsive support mode execution process (S20).

In the process S20, the support device 12 is activated to execute a responsive support mode. Here, the responsive support mode refers to the support mode forewarned in the process S16, and is set to an emergency responding mode in this case. The support device 12 transitions from the drive support mode to the emergency responding mode, and operates the notification unit 15 to notify the driver of this fact. As the process S20 is terminated, the flow advances to a function abort process (S22).

In the process S22, the support device 12 is activated to control a vehicle in an emergency responding mode. In the emergency responding mode, the support function for alleviating a drive burden is turned off among the drive support functions being executed, and the support function focusing on driving or traveling safety is turned on in a case where the support function focusing on driving or traveling safety is turned off. For example, in a case where a seat belt roll-up function is included in the drive support such as a rear-end collision alarm, the support device 12 turns off the seat belt roll-up function in order to prevent excessive stimulation to a driver's heart. In addition, the support device 12 limits, for example, the acceleration/deceleration function of the ACC to prevent abrupt acceleration/deceleration. Moreover, the support device 12 turns on, for example, LDW, LDP, and the like that are not being executed. As such, when a driver is in an emergency, overall drive support is not turned off. That is, depending on an example of the sickness, the support function for alleviating a travel burden is turned off, and the function focusing on driving or traveling safety is newly turned on. Therefore, it is possible to provide a driver with optimal support. As the process S22 is terminated, the flow advances to a device state determination process (S24).

The process S24 is similar to that described in conjunction with the first embodiment. If the device state determination unit 13 determines that the functions of the support device 12 are operating normally in the process S24, the flow advances to a support initiation process (S26).

The process S26 is similar to that described in conjunction with the first embodiment. As the process S26 is terminated, the control process of FIG. 2 is terminated.

Meanwhile, if the device state determination unit 13 determines that the functions of the support device 12 are not normally operated in the process S24, the flow advances to a device state notification process (S32). The process S32 is similar to that described in conjunction with the first embodiment. As the process S32 is terminated, the control process of FIG. 2 is terminated.

Hereinbefore, in the device responding to improper drive according to the second embodiment, in a case where the driver's alertness is lower than a threshold value, the support device 12 notifies a driver of the fact that the mode will be changed to the emergency responding mode, and then, the mode of the support device 12 changes from the drive support mode to the emergency responding mode.

Since it is possible to allow a driver to determine whether or not the device is operating normally by notifying him or her of information on the operation of the device, it is possible to prevent the driver from being confused or overconfident. For example, even when device malfunction, error detection, or the like occurs, it is possible to alleviate driver discomfort or distrustfulness and provide the driver with an optimal response.

In the device responding to improper drive according to the second embodiment, the support device 12 can change the mode to the emergency responding mode after a predetermined time period subsequent to notification to a driver. Therefore, it is possible to set a time for making a driver understand the operation executed by the device. Accordingly, it is possible to further prevent a driver from being confused or overconfident.

In the device responding to improper drive according to the second embodiment, in a case where an instruction for aborting change to the emergency responding mode is received through the manipulation input unit 10 within a predetermined time period, the change to the emergency responding mode is aborted by the support device 12. Therefore, it is possible to abort control of the device based on a driver's instruction. Accordingly, it is possible to provide a driver with an optimal response.

In the device responding to improper drive according to the second embodiment, in a case where driver's alertness is lower than the threshold value while the support function for alleviating a drive burden is executed, the functions being executed are aborted by the support device 12, and the support focusing on drive safety or travel safety is initiated. As such, in a case where driver's alertness is lower than a threshold value, the overall drive support is not aborted, but the support focusing on driving or traveling safety may be provided. Therefore, it is possible to provide a driver with an optimal response.

Although each of the aforementioned embodiments has been described to illustrate an exemplary device responding to improper drive according to the invention, they are not intended to limit the invention. The devices responding to improper drive according to each embodiment may be modified to another form without departing from the spirit and scope of the invention as described in each claim.

For example, although characters are exemplarily displayed on the multi-information display according to each of the aforementioned embodiments, icons may be displayed.

Each of the aforementioned embodiments illustrates an example in which the support device 12 turns off the support function for alleviating a drive burden and turns on the support function focusing on driving or traveling safety in the process S22. In the process S26, the support devices 12 initiates the support associated with the function turned on in the process S22. That is, although description has been made for an example in which the support function for alleviating a drive burden is turned off, and then, the support focusing on driving or traveling safety is initiated, the invention is not limited thereto. For example, the support device 12 may turn off the support function for alleviating a drive burden, and initiate the support focusing on driving or traveling safety at the same time. In this case, since the operation would be easily understood by a driver, it is possible to further reduce the driver's discomfort or distrustfulness. Alternatively, for example, the support device 12 may initiate the support focusing on driving or traveling safety before the support function for alleviating a drive burden is turned off. As a result, it is possible to quickly provide the support focusing on drive or travel safety. Alternatively, the support device 12 may change a relationship between the timing for turning off the support function for alleviating a drive burden and the timing for initiating the support focusing on driving or traveling safety based on a vehicle travel state and the like such that a driver is guided to drive or travel safely in consideration of the driver's convenience.

Although the description in each of the aforementioned embodiments has been made for an example in which the drive support item is changed by the support device 12 when the driver's alertness is lower than the threshold value, the driver's alertness may be evaluated without using the threshold value. For example, the support device 12 may be configured to change the drive support items when the alertness is included in a predetermined range. In addition, although description in each of the aforementioned embodiments has been made for an example in which the support device 12 changes the control mode after the control mode to be changed is notified in a case where the driver's alertness is lower than the threshold value, the control mode may be changed after the control mode to be changed is notified in a case where the driver's alertness is higher than the threshold value. Consequently, the support device 12 may have a function of changing the control mode depending on the driver's alertness.

### Reference Signs List

1 . . . device responding to improper drive,

10 . . . manipulation input unit (input unit),

11 . . . driver's condition detector,

12 . . . support device (support processing unit, notification unit),

13 . . . device state determination unit,

14 . . . detector state determination unit,

15 . . . notification unit

1. A device responding to improper drive for providing drive support based on a driver's alertness, the device comprising:
a support processing unit that changes from a first control mode to a second control mode depending on the driver's alertness during an execution of the first control mode; and
a notification unit that notifies a driver of a fact that the support processing unit changes the control mode to the second control mode,
wherein the support processing unit changes the control mode after the notification unit notifies the driver.

2. The device according to claim 1, wherein the support processing unit changes the control mode at a time interval after the notification unit notifies the driver.

3. The device according to claim 2, further comprising an input unit that receives an instruction for aborting the change of the control mode to the second control mode from the driver after the notification unit notifies the driver before the support processing unit changes the control mode,
wherein the support processing unit aborts the change of the control mode when the input unit receives the instruction.

4. A device responding to improper drive for providing drive support based on a driver's alertness, the device comprising a support processing unit that aborts a first support function for alleviating a drive burden depending on the driver's alertness during the first support function and initiates a second support function focusing on drive safety or travel safety.
